(19) United States
(12) Patent Application Publication
(10) Pub. No.: US 2026/0173014 A1
(43) Pub. Date: Jun. 18, 2026

(54) MULTIPLE NODES FOR USER EQUIPMENT POSITIONING

(71) Applicant: Lenovo (Singapore) Pte. Limited, Singapore (SG)

(72) Inventors: Khaled Nafez Rauf Ardah, Ilmenau (DE); Robin Rajan Thomas, Bad Nauheim (DE)

(73) Assignee: Lenovo (Singapore) Pte. Limited, Singapore (SG)

(21) Appl. No.: 19/111,395

(22) PCT Filed: Nov. 22, 2023
(86) PCT No.: PCT/IB2023/061807

§ 371 Date: Mar. 13, 2025

Related U.S. Application Data
(60) Provisional application No. 63/385,584, filed on Nov. 30, 2022.

(51) Int. Cl. H04W 64/00

(52) U.S. Cl. CPC H04W 64/00

(57) ABSTRACT

Various aspects of the present disclosure relate to methods, apparatuses, and systems that support multiple nodes for user equipment positioning. For instance, anchor nodes are configured to cooperate (e.g., via backhaul and/or OTA transmission) to exchange position-related parameters and confidence information pertaining to the position-related parameters. Further, subband non-overlapping full duplex (SBFD) can be used for OTA transmission to occur in a DL subband that is configured to overlap with the UL subband.

### RELATED APPLICATION

This application claims priority to U.S. Provisional Application Ser. No. 63/385,584 filed 30 Nov. 2022 entitled “Multiple Nodes for User Equipment Positioning,” the disclosure of which is incorporated by reference herein in its entirety.

### TECHNICAL FIELD

The present disclosure relates to wireless communications, and more specifically to position determination in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for attempting to determine location of UEs. However, such communication systems currently are limited in their ability to utilize data that can be shared across the systems.

### SUMMARY

The present disclosure relates to methods, apparatuses, and systems that support multiple nodes for user equipment positioning. For instance, anchor nodes are configured to cooperate (e.g., via backhaul and/or Over-The-Air (OTA) transmission) to exchange position-related parameters and confidence information pertaining to the position-related parameters. Further, subband non-overlapping full duplex (SBFD) can be used for OTA transmission to occur in a downlink (DL) subband that is configured to overlap with the Uplink (UL) subband.

By utilizing the described techniques, accuracy of position determination in wireless communications systems can be increased, while decreasing signaling and processing overhead.

Some implementations of the method and apparatuses described herein may further include receiving, at a first anchor node, reference signals from a target UE; processing the reference signals to generate a first estimated position-related parameter between the first anchor node and the target UE, and a first confidence value for the first estimated position-related parameter; and transmitting a first notification of the first estimated position-related parameter and the first confidence value to a second anchor node.

Some implementations of the method and apparatuses described herein may further include receiving one or more reference signal time-frequency configurations; and receiving the reference signals from the target UE based at least in part on the one or more reference signal time-frequency configurations; further including generating the first estimated position-related parameter based at least in part on one or more of an estimated time of arrival of a first path between the first anchor node and the target UE, an estimated azimuth angle of arrivals of the reference signals of the first path, or an estimated zenith angle of arrivals of the reference signals of the first path; receiving, from the second anchor node, a second estimated position-related parameter between the second anchor node and the target UE and a second confidence value for the second estimated position-related parameter; modifying, based at least in part on the second estimated position-related parameter and the second confidence value, the first estimated position-related parameter to generate a third estimated position-related parameter between the first anchor node and the target UE; and transmitting the third estimated position-related parameter and a third confidence value for the third estimated position-related parameter to a network entity.

Some implementations of the method and apparatuses described herein may further include at least one of the first confidence value, the second confidence value, or the third confidence value is based on at least one of link quality with the target UE or whether a line of sight path is available to the target UE; comparing the first confidence value to a threshold confidence value; and transmitting the first notification to the second anchor node based at least in part on the first confidence value meeting the threshold confidence value; receiving, from the second anchor node, a request for a position-related parameter information for the target UE; and transmitting the first notification to the second anchor node based at least in part on the request; selecting the first confidence value from a predetermined set of different confidence values; selecting the first estimated position-related parameter from a predetermined set of position-related parameter values that represent different position-related parameter ranges; determining one or more of an estimated azimuth angle of arrivals or an estimated zenith angle of arrivals of the reference signals over a first path between the first anchor node and the target UE based at least in part on one or more of a set of predetermined azimuth angle of arrivals values or a set of predetermined zenith angle of arrivals values that represent different slices of an angular domain; and transmitting the one or more of the estimated azimuth angle of arrivals or the estimated zenith angle of arrivals to the second anchor node in conjunction with the first notification.

Some implementations of the method and apparatuses described herein may further include transmitting one or more of the first estimated position-related parameter, the first confidence value, or the one or more of the estimated azimuth angle of arrivals or the estimated zenith angle of arrivals via a backhaul connection; transmitting one or more of the first position-related parameter, the first confidence value, or the one or more of the estimated azimuth angle of arrivals or the estimated zenith angle of arrivals via an over-the-air transmission; receiving time and frequency resources for the over-the-air transmission, and where the time and frequency resources are configured within a downlink subband that overlaps with an uplink subband used for the reference signals; configuring time domain resources for the over-the-air transmission within an offset relative to a first time domain symbol of an uplink configuration used for the reference signals; the first anchor node includes a first UE, the second anchor node includes a second UE, and the target UE includes a UE for which an estimated location is to be determined; the first anchor node includes a first network device, the second anchor node includes a second network device, and the target UE includes a UE for which an estimated location is to be determined; one or more of the first network device or the second network device includes at least one of a base station, a gNB, or a roadside unit.

Some implementations of the method and apparatuses described herein may further include generating a notification including one or more time-frequency configurations and confidence configuration pertaining to distance determination; transmitting the notification to a first anchor node; and receiving, from the first anchor node, an estimated position-related parameter between the first anchor node and a target UE, and a first confidence value for the first estimated position-related parameter.

Some implementations of the method and apparatuses described herein may further include where the one or more time-frequency configurations are configured for one or more of positioning reference signals or sounding reference signals; the confidence configuration includes a predetermined set of different confidence values; the notification further includes a predetermined set of position-related parameter values that represent different position-related parameter ranges; the notification includes a predetermined set of angle of arrival values that represent different slices of an angular domain for use in position-related parameter determination; the one or more time-frequency configurations identify time and frequency resources within a downlink subband that overlaps with an uplink subband used for reference signals; the first anchor node includes a first UE and the target UE includes a UE for which an estimated location is to be determined; first anchor node includes a first network device and the target UE includes a UE for which an estimated location is to be determined; the first network device includes at least one of a base station, a gNB, or a roadside unit.

### BRIEF DESCRIPTION OF THE DRAWINGS

FIG. 1 illustrates an example of a wireless communications system that supports multiple nodes for UE positioning in accordance with aspects of the present disclosure.

FIG. 2 illustrates a procedure including messaging for performing an Uplink Time Difference of Arrival (UL-TDOA) procedure.

FIG. 3 illustrates a procedure including messaging for performing an Uplink Angle of Arrival (UL-AoA) procedure.

FIG. 4 illustrates at a time/frequency domain pattern for a carrier used for SBFD operation from a system perspective.

FIG. 5 illustrates at a time/frequency domain pattern from a UE perspective within a ‘D’ slot.

FIG. 6 illustrates at AoA and range quantization that supports multiple nodes for UE positioning in accordance with aspects of the present disclosure.

FIG. 7 illustrates an UL/SL communication system that supports multiple nodes for UE positioning in accordance with aspects of the present disclosure.

FIG. 8 illustrates at an example of received CIR at an anchor node.

FIG. 9 illustrates a scenario that supports multiple nodes for UE positioning in accordance with aspects of the present disclosure.

FIG. 10 illustrates at an example that supports multiple nodes for UE positioning in accordance with aspects of the present disclosure.

FIG. 11 illustrates a procedure including a signaling flow that supports multiple nodes for UE positioning in accordance with aspects of the present disclosure.

FIG. 12 illustrates at OTA communication between anchor nodes that supports multiple nodes for UE positioning in accordance with aspects of the present disclosure.

FIG. 13 illustrates where OTA transmission can be configured to occur in a DL subband that is configured to overlap with the UL subband.

FIG. 14 illustrates an example of a block diagram of a device (e.g., an apparatus) that supports multiple nodes for UE positioning in accordance with aspects of the present disclosure.

FIG. 15 illustrates a flowchart of a method that supports multiple nodes for UE positioning in accordance with aspects of the present disclosure.

FIG. 16 illustrates a flowchart of a method that supports multiple nodes for UE positioning in accordance with aspects of the present disclosure.

FIG. 17 illustrates a flowchart of a method that supports multiple nodes for UE positioning in accordance with aspects of the present disclosure.

### DETAILED DESCRIPTION

In some wireless communications systems, ways are provided for estimating locations of devices, such as UEs. For instance, in UL and/or sidelink (SL) based wireless positioning techniques, a target UE can transmit reference signals to multiple anchor nodes, e g., serving and/or neighbouring anchor nodes. The anchor nodes can estimate position-related parameters (e.g., Relative Time of Arrival (RTOA), UL-AoA, etc.) from received Channel Impulse Response (CIR) measurements. The position-related parameters can be used to determine (e.g., estimate) the targe UE position.

In various scenarios, a target UE may have a different link quality with different anchor nodes. Thus, an estimation accuracy of position-related parameters pertaining to the target UE may vary from one anchor to another. For example, an anchor node having a high link signal quality with the target UE may estimate the position-related parameters with higher accuracy compared to another anchor node having a lower link signal quality with the target UE. However, according to implementations, anchor nodes can be configured to cooperate with each other by means of exchanging position-related parameters, thus enabling estimation accuracy of position-related parameters to be improved, which can improve target UE position estimation accuracy. This can be beneficial for SL positioning scenarios, such as where anchor nodes (e.g., UEs) may be distributed with respect to the target UE.

Accordingly, the current disclosure introduces a cooperation methodology to enable anchor nodes to cooperate to exchange position-related parameters and to increase position estimation accuracy for target UEs. For instance, anchor nodes having a high link quality with a target UE can provide assistance information to other anchor nodes having a lower link quality to improve the estimation accuracy of their position-related parameters.

Thus, by utilizing the described techniques, accuracy of position determination in wireless communications systems can be increased, while decreasing signaling and processing overhead.

Aspects of the present disclosure are described in the context of a wireless communications system. Aspects of the present disclosure are further illustrated and described with reference to device diagrams and flowcharts.

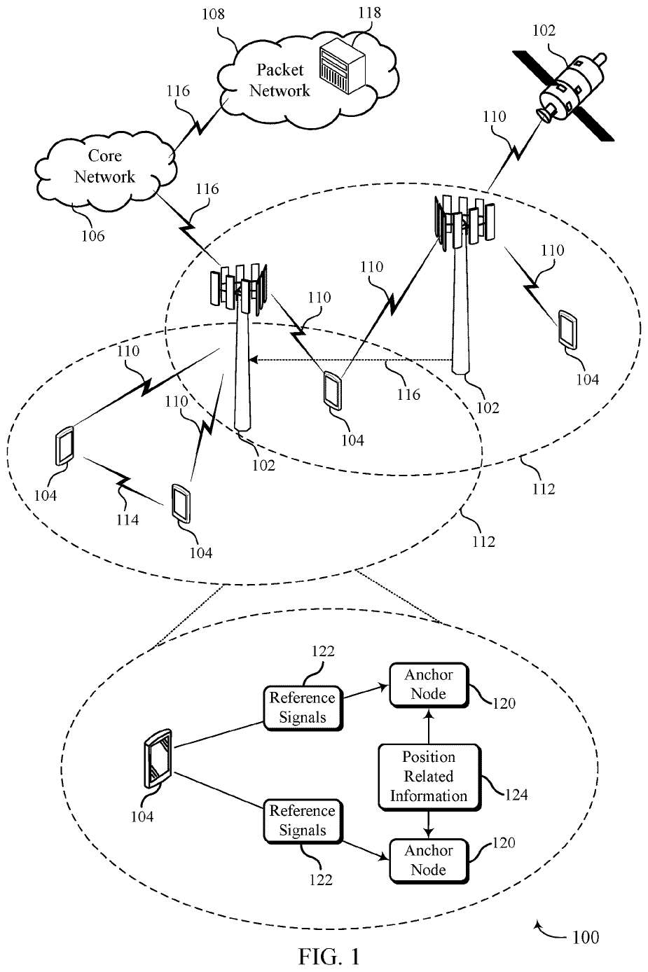

FIG. 1 illustrates an example of a wireless communications system 100 that supports multiple nodes for UE positioning in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., PHY layer) or an L2 (e.g., radio link control (RLC) layer, MAC layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a Protocol Data Unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FRI may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for multiple nodes for UE positioning, multiple anchor nodes 120 cooperate to determine a position of a target UE 104. The anchor nodes 120 can be implemented in various ways, such as anchor UEs, network devices (e.g., base stations, gNBs, roadside units (RSUs)), etc. Thus, implementations may include exchange of location data via sidelink transmission, Uu transmission, and combinations thereof.

Further to the wireless communications system 100, the anchor nodes receive reference signals 122 from the target UE 104. The reference signals 122 can be implemented in various ways, such as Positioning Reference Signals (PRS), Sounding Reference Signals (SRS), and/or other suitable signal that can be utilized for position determination. Accordingly, the anchor nodes 120 process the reference signals 122 and exchange position related information 124 based at least in part on processing the reference signals 122. As further described below, the position related information can include position-related parameters and estimation-confidence parameters pertaining to the position-related parameters. Based at least in part on the position related information 124, the anchor nodes 120 can estimate a position (e.g., location) of the target UE 104. Further, the anchor nodes 120 can communicate an estimate position of the target UE 104 to another entity, such as a network entity 102.

In some wireless communications systems, NR positioning based on NR Uu signals and Stand Alone (SA) architecture (e.g., beam-based transmissions) was first specified in Rel-16. The targeted use cases also included commercial and regulatory (emergency services) scenarios as in Rel-15. The performance requirements include the following in Table 1 [Technical Report (TR) 38.855]:

TABLE 1

| Positioning | | |
|---|---|---|
| Error | Indoor | Outdoor |
| Horizontal | <3 m for 80% | <10 m for 80% |
| Positioning | of UEs | of UEs |
| Vertical | <3 m for 80% | <3 m for 80% |
| Positioning | of UEs | of UEs |

Some positioning systems define positioning performance parameters for Commercial and IIoT use cases as follows in Table 2 [TR 38.857]:

TABLE 2

| Positioning | | |
|---|---|---|
| Error | Commercial | IIoT |
| Horizontal | (<1 m) for 90% of | (<0.2 m) for 90% of |
| Positioning | UEs | UEs; |
| Vertical | (<3 m) for 90% of | (<1 m) for 90% of |
| Positioning | UEs | UEs |
| Physical layer | (<10 ms) | (<10 ms) |
| latency for | | |
| position | | |
| estimation of | | |
| UE | | |
| End-to-End | (<100 ms) | (<100 ms, in the |
| Latency for | | order of 10 ms is |
| position | | desired) |
| estimation of | | |
| UE | | |

Examples of positioning techniques include the following in Table 3:

TABLE 3

| | | | NG-RAN | |
|---|---|---|---|---|
| | | UE-assisted, | node | |
| Method | UE-based | LMF-based | assisted | SUPL |
| A-GNSS | Yes | Yes | No | Yes (UE-based and |
| | | | | UE-assisted) |
| OTDOA ^{Note1, Note 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL- | Yes | Yes | No | No |
| TDOA | | | | |
| DL-AoD | Yes | Yes | No | No |
| Multi- | No | Yes | Yes | No |
| RTT | | | | |
| NR E- | No | Yes | FFS | No |
| CID | | | | |
| UL- | No | No | Yes | No |
| TDOA | | | | |
| UL-AoA | No | No | Yes | No |

^{Note 1}
This includes Terrestrial Beacon System (TBS) positioning based on PRS signals.
^{Note 2}
In this version of the specification only Observed Time Difference Of Arrival (OTDOA) based on LTE signals is supported.
^{Note 4}
This includes Cell-Identifier (ID) for NR method.
^{Note 5}
In this version of the specification only for TBS positioning based on Multicast and Broadcast Services (MBS) signals.

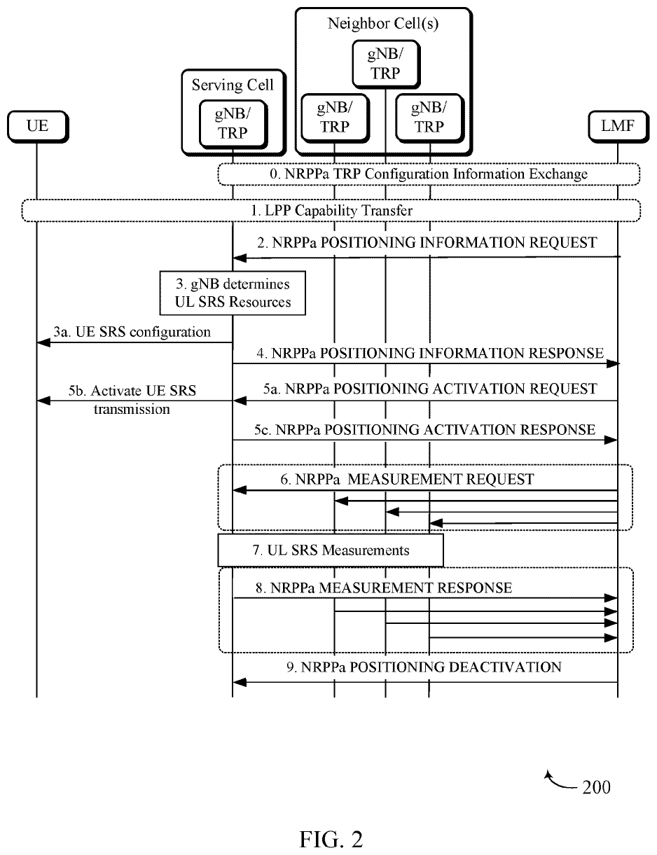

FIG. 2 illustrates a procedure 200 including messaging for performing an Uplink Time Difference of Arrival (UL-TDOA) procedure. The procedure 200, for instance, includes messaging between an LMF, gNBs, and a UE to perform an UL-TDOA procedure.

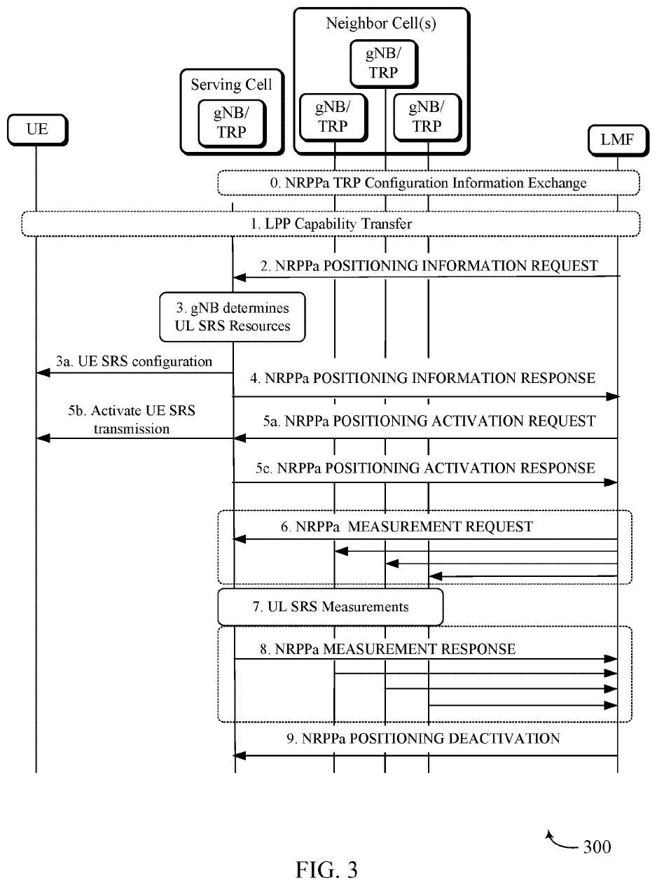

FIG. 3 illustrates a procedure 300 including messaging for performing an Uplink Angle of Arrival (UL-AoA) procedure. The procedure 300, for instance, including messaging between an LMF, gNBs, and a UE to perform an UL-AoA procedure.

In some wireless communications systems, anchor gNBs in the UL-based positioning methods may not cooperate with each other when estimating the position-related parameters. Accordingly, in implementations the present disclosure includes an intermediate step between Step 7 and Step 8 in the above procedures 200, 300, where the anchor gNBs communication with each other via backhaul and/or OTA transmission, which may enhance the estimation accuracy and reduce computational complexity of UL-based positioning methods.

In some wireless communications systems, SBFD in NR has been discussed. For instance, a maximum number of UL subbands for SBFD operation in an SBFD symbol (excluding legacy UL symbol) within a Time Division Duplex (TDD) carrier has been considered, where the UL subband can be located at one side of the carrier and the UL subband can be located at the middle part of the carrier.

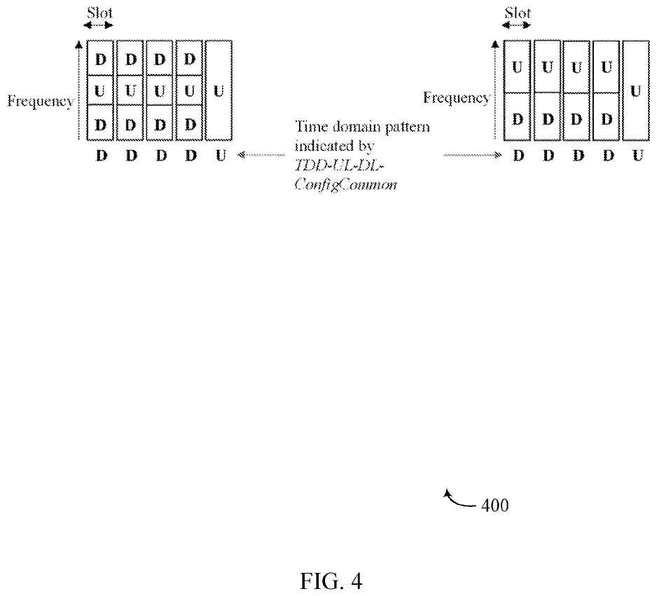

FIG. 4 illustrates at 400 a time/frequency domain pattern for a carrier used for SBFD operation from a system perspective. A baseline time-domain TDD UL/DL pattern, e.g., D-D-D-D-U is indicated cell-specifically with TDD-UL-DL-ConfigCommon, which can be the same for all UEs in the cell. In SBFD operation, symbols within ‘D’ slots can be configured with frequency domain pattern D-U-D, D-U, or U-D. The U slot(s)/symbols in the time domain pattern is/are preserved for UL operation for both Rel-18 and legacy UEs.

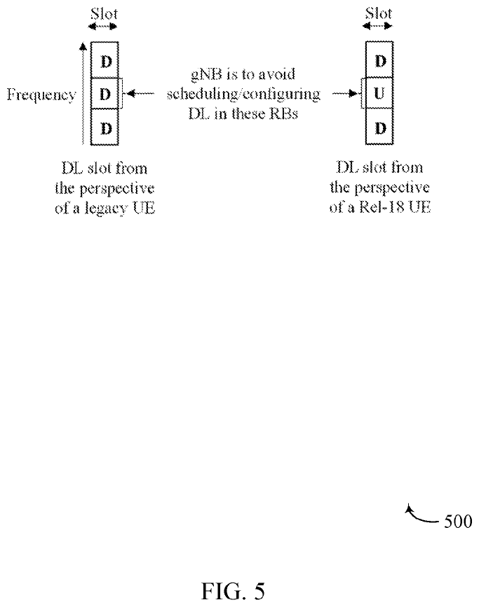

FIG. 5 illustrates at 500 a time/frequency domain pattern from a UE perspective within a ‘D’ slot. For instance, from a UE perspective, a ‘D’ slot in the above time domain pattern at 400 may appear as shown at 500. A legacy UE may see the slot as configured for DL reception only, but the gNB may avoid scheduling and/or configuring DL transmission in the middle RBs for this UE. A legacy UE may be unaware that these RBs can be used for UL by Rel-18 UEs. This can cause constraints on the configuration and scheduling of DL for legacy UEs, e.g., some signals and/or channels are to be scheduled and/or configured in one of the ‘D’ subbands. For Rel-18 UEs, the UE may be configured such that a ‘D’ slot in the above pattern can be used for either DL reception or UL transmission, e.g., not simultaneously. While the gNB may avoid scheduling and/or configuring DL in the middle RBs, new behavior for certain signals and/or channels can be specified for making use of both ‘D’ subbands.

To improve on challenges presented in some wireless communications systems, the present disclosure details solutions for multiple nodes for UE positioning. For instance, different anchor nodes (e.g., UEs, network devices, and combinations thereof) involved in enabling position determination for a target UE can cooperate to exchange position-related parameters and confidence information related to the position-related parameters to provide for more precise determine of the target UE position.

In implementations, a first anchor node is configured to convey one or more of its estimated position-related parameters along with its estimation-confidence parameter (e.g., a confidence value, a confidence level, etc.) to a second anchor node, which can be used by the second anchor node for optimizing an estimation accuracy of the second anchor node's position-related parameters. For example, anchor nodes with lower quality position-related parameters (e.g., anchor nodes having poor link quality with the target UE) can utilize other position-related parameters estimated by anchor nodes with higher-quality position-related parameters, e.g., anchor nodes having high link quality with the target UE when estimating their own position-related parameters.

According to implementations, a first anchor node (e.g., an anchor UE, a gNB, a roadside unit (RSU), etc.) receives reference signal configuration (e.g., for position reference signal (PRS), SRS, etc.) from a configuration entity, e.g., an LMF. Further, the first anchor node receives reference signals from a target UE for which an estimated location is to be determined. The first anchor node estimates position-related parameters, determines an estimation-confidence parameter, and conveys one or more of its estimated position-related parameters along with its estimation-confidence parameter to a second anchor node. The second anchor node, for example, represents a different anchor UE, a different gNB, a different RSU, etc.

In implementations, an anchor node determines its estimation-confidence parameter, denoted hereafter by c, by considering one or more of:
A link quality between the anchor node and the target UE. The link quality may be determined based on various factors, such as Signal to Interference plus Noise Ratio (SINR), Reference Signal Received Power (RSRP), etc. For instance, a SINR value above a SINR threshold indicates a high estimation-confidence, and a SINR value below the SINR threshold indicates low estimation-confidence.
Line of sight (LOS) status. For instance, availability of LOS between an anchor node and a target UE indicates high estimation-confidence, where non-LOS (LOS) may indicate a low estimation-confidence.

In implementations, an anchor node may transmit position-related parameters to another anchor node if its estimation-confidence is higher than a predefined threshold, and may decide not to convey position-related parameters to another anchor node if its estimation-confidence is lower than the predefined threshold.

In implementations, a first anchor node may share its position-related parameters with a second anchor node using sidelink (e.g., PC5) signaling, e.g., using Sidelink Control Information (SCI), a Media Access Control (MAC) Control Element (CE), a new positioning protocol (e.g., Ranging Sidelink Positioning Protocol (RSPP), SL Positioning Protocol (SLPP)), the SL ProvideAssistanceData message, the SL ProvideLocationInformation message, etc.

In implementations, position-related parameters at a first anchor node may include measurements already performed at the first anchor node, such as AoA (e.g., azimuth and/or zenith angles), UE Receive-Transmit (Rx-Tx) time difference measurements, Reference Signal Time Difference (RSTD) measurements, RTOA measurements, etc. These measurements may be applicable to SL positioning measurements.

In implementations information shared by the first anchor node may include estimation-confidence or quality metrics associated with one or more of the aforementioned measurements performed at the first anchor node. Further, information shared by the first anchor node may include path indications for each of the position-related parameter measurements, which may include an associated path number received at a particular delay and amplitude.

In implementations, location information (e.g., position-related parameters, estimation-confidence parameters, etc.) shared by a first anchor node may be provided to a second anchor node in response to a reception of a request message from the second anchor node for one or more types of the aforementioned location information. The request, for instance, may include indications of whether such location information is to be provided in an aperiodic manner (e.g., one shot), a periodic manner (e.g., System Frame Number (SFN) slot offset value, configured periodicity and number of intervals, etc.), a semi-persistent manner (e.g., with activation and deactivation command), and so forth. Further, location information shared by a first anchor node may be associated with an anchor ID, such as to identify the origin of the shared location information.

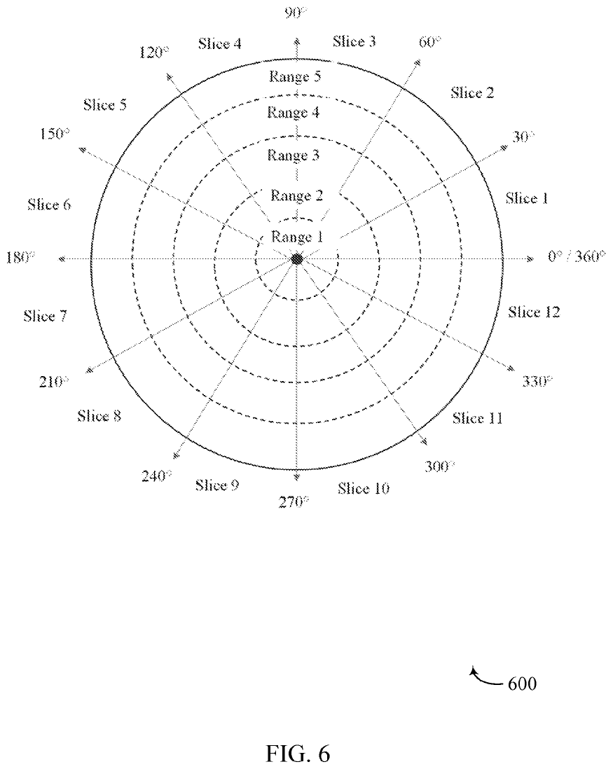

FIG. 6 illustrates at 600 AoA and range quantization that supports multiple nodes for UE positioning in accordance with aspects of the present disclosure. Further, Table 4, Table 5, and Table 6 include indices that can be utilized to indicate position-related parameters and estimation-confidence parameters.

TABLE 4
Estimation-Confidence Levels

| Index | Estimation-confidence cₖ |
|---|---|
| 1 | Very low confidence, e.g., 0 ≤ cₖ < |
| | 0.2 |
| 2 | Low confidence, e.g., 0.2 ≤ cₖ < |
| | 0.4 |
| 3 | Medium confidence, e.g., 0.4 ≤ cₖ < |
| | 0.6 |
| 4 | High confidence, e.g., 0.6 ≤ cₖ < |
| | 0.8 |
| 5 | Very high confidence, e.g., 0.8 ≤ |
| | cₖ ≤ 1 |

TABLE 5
Distance (e.g., range) Estimation (d)

| Index | Range with respect to cell radius R |
|---|---|
| 1 | Range 1: 0 ≤ d < 0.2R |
| 2 | Range 2: 0.2R ≤ d < 0.4R |
| 3 | Range 3: 0.4R ≤ d < 0.6R |
| 4 | Range 4: 0.6R ≤ d < 0.8R |
| 5 | Range 5: 0.8R ≤ d ≤ R |

TABLE 6
Azimuth and Zenith AoA angles φ, θ

| | Azimuth AoA range | Zenith AoA range |
|---|---|---|
| | quantization with 30° | quantization with 30° |
| Index | step | step |
| 1 | Slice 1: 0 ≤ φ < 30° | Slice 1: 270° ≤ θ < 300° |
| 2 | Slice 2: 30° ≤ φ < 60° | Slice 2: 300° ≤ φ < 330° |
| 3 | Slice 3: 60° ≤ φ < 90° | Slice 3: 330° ≤ φ < 0° |
| . | . | . |
| . | . | . |
| . | . | . |
| 12 | Slice 12: 330° ≤ φ < 360° | Slice 6: 60° ≤ φ < 90° |

In implementations, a first anchor node may explicitly indicate its estimation-confidence parameter and position-related parameters to a second anchor node (e.g., via backhaul connections and/or OTA transmissions (e.g., via a SL (PC5) interface)) using one or more indices, e.g., as shown in Table 4, Table 5, and Table 6 and illustrated in FIG. 6. The indices, for instance, may be represented, such as by a number of bits. The number of bits, for example, may be pre-configured by a network. Further, bits may be modulated and/or coded, e.g., using a pre-configured Modulation and Coding Scheme (MCS).

In implementations, bits may be transmitted on a subset of resource elements (REs). Further, one or more of the levels, ranges, and/or slices may be indicated implicitly, such as by selecting different signal sequence types (e.g., Zadoff-Chu, Gold, etc.) and/or different sequence parameters, e.g., root, cyclic shift, length, etc. Further, a combination of explicit and implicit indications may be used, e.g., an explicit indication of an estimated range (e.g., distance) and implicit indication of the estimation-confidence level.

Note that in implementations, quantized values of confidence level, distance range, and AoAs slice can be used to simplify a parameter exchange between the different anchor nodes. However, in a final measurement response report from anchor nodes (e.g., to LMF), high-resolution values may be reported to enable high resolution position estimation, e.g., by LMF.

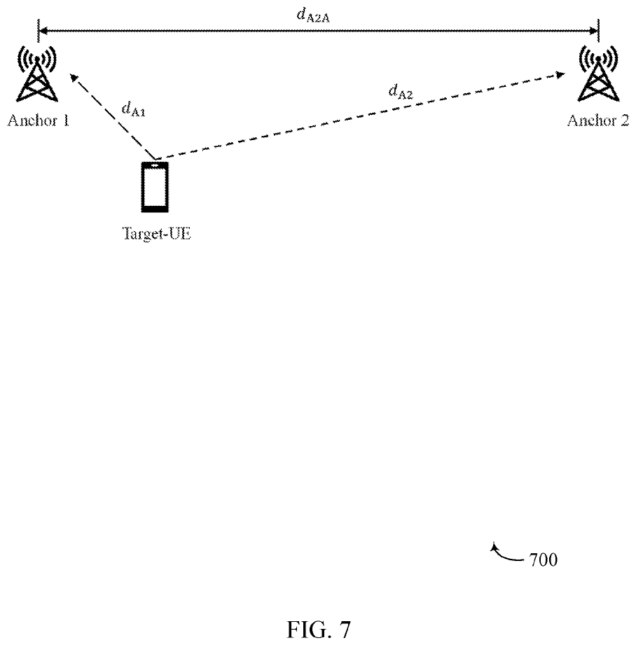

FIG. 7 illustrates an UL/SL communication system 700 that supports multiple nodes for UE positioning in accordance with aspects of the present disclosure. The communication system 700 includes two anchor nodes (Anchor 1 and Anchor 2) and a target-UE, which is to be located. In implementations, where Anchor 1 and Anchor 2 have signal links with the target-UE that are indicated as meeting a threshold link quality, each anchor node can estimate position-related parameters (e.g., ToA, AoA, etc.) from its received CIR signals and use the position-relate parameters to calculate an estimated position of the target-UE. In at least some scenarios, the target-UE may have a higher link quality with Anchor 1 than with Anchor 2. Anchor 1, for instance, can estimate position-related parameters pertaining to the Target-UE with higher accuracy than Anchor 2.

For example, Anchor 1 and Anchor 2 can use their received CIR to estimate the ToA τ_{A1} and τ_{A2}, respectively, e.g., using a noise-thresholding technique. Consider, for example, that Anchor 1 has a higher quality link quality with the Target-UE than Anchor 2, and thus Anchor 1 may be able to calculate the ToA τ_{A1} with high accuracy, such as due to more accurate noise-threshold calculation than Anchor 2. Using the estimated ToA τ_{A1}, Anchor 1 can calculate the distance d_{A1} between Anchor 1 and the Target-UE.

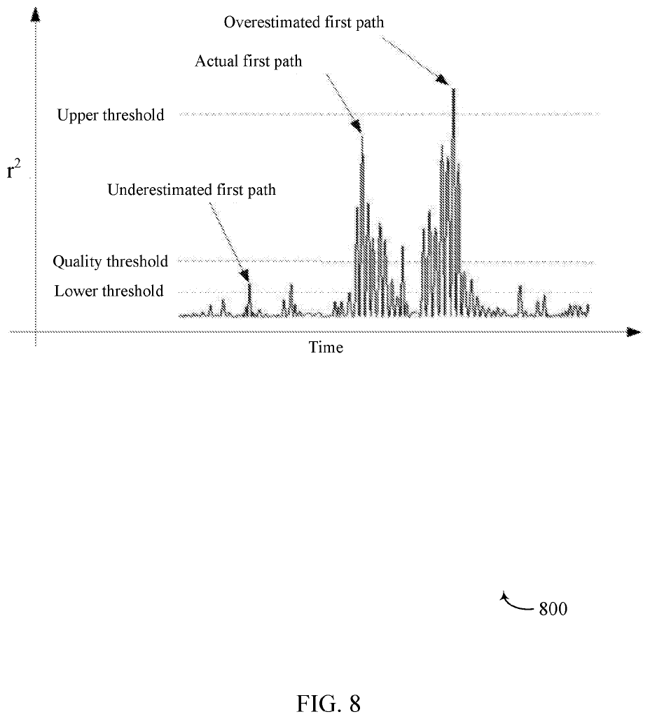

FIG. 8 illustrates at 800 an example of received CIR at an anchor node. (Lei Yu, M. Laaraiedh, S. Avrillon, B. Uguen, J. Keignart and J. Stephan, “Performance evaluation of threshold-based TOA estimation techniques using IR-UWB indoor measurements,” European Wireless 2012; 18th European Wireless Conference 2012, 2012, pp. 1-7). As illustrated at 800, due to a lower link quality, an anchor node might use a less accurate (under or over) noise-threshold that leads to an under-estimation or an over-estimation of the ToA τ_{A2} of the real first path, as illustrated at 800.

To mitigate this issue, Anchor 1 can be configured to send one or more of its estimated position-related parameters (e.g., τ_{A1}, d_{A1}, etc.) to Anchor 2 to enable Anchor 2 to use the estimated position-related parameters to improve estimation accuracy of position-related parameters.

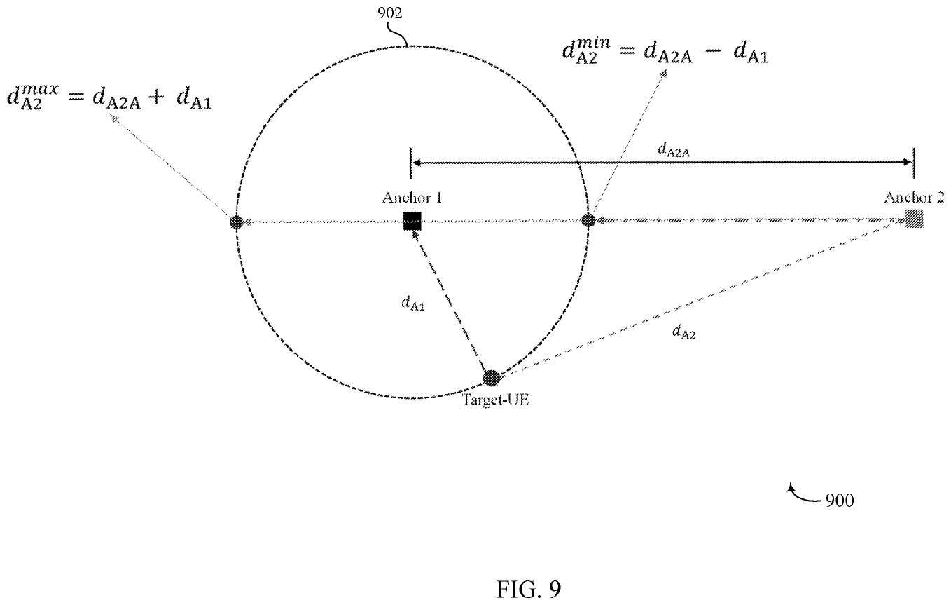

FIG. 9 illustrates a scenario 900 that supports multiple nodes for UE positioning in accordance with aspects of the present disclosure. In the scenario 900, a calculated distance d_{A1} by Anchor 1 indicates that the Target UE is estimated to be located at a point on a circumference 902 that is centered by a location of Anchor 1 and having radius of d_{A1}. In implementations, the circumference 902 represents a positioning uncertainty. Consider further that if Anchor 2 has access to d_{A1}, Anchor 2 can use d_{A1} and the known distance between Anchor 1 and Anchor 2 (denoted by d_{A2A}) to estimate its minimum and maximum distance to the Target UE, e.g.,

$${d}_{A 2}^{min} and {d}_{A 2}^{max} ,$$

as illustrated in the upper portion of the scenario 900. Using

$${d}_{A 2}^{min} and {d}_{A 2}^{max} ,$$

Anchor 2 can calculate

$${τ}_{A 2}^{min} and {τ}_{A 2}^{max} ,$$

which can then be used as two vertical thresholds when calculating ToA τ_{A2}, as illustrated in the lower portion of the scenario 900. This can not only improve the estimation accuracy of the ToA τ_{A2}, but can also reduce its complexity.

In implementations, when there are K anchors, each anchor node can receive messages from \tilde{K}≤K−1 anchors (e.g., \tilde{K} ToAs and/or \tilde{K} AoAs). Accordingly, each anchor node k can be configured to convey its estimation-confidence cₖ along the estimated position-related parameters, e.g., ToA and AoA. Thus, anchor node j, for example, can use the received messages from one or more anchors having the highest estimation-confidence (e.g., a received message d_{Ak}* from anchor node k*, where k*=argmax {cₖ}) to calculate its minimum and maximum thresholds, e.g.,

$${d}_{Aj}^{min} , {d}_{Aj}^{max} , {τ}_{Aj}^{min} , and {τ}_{Aj}^{max} .$$

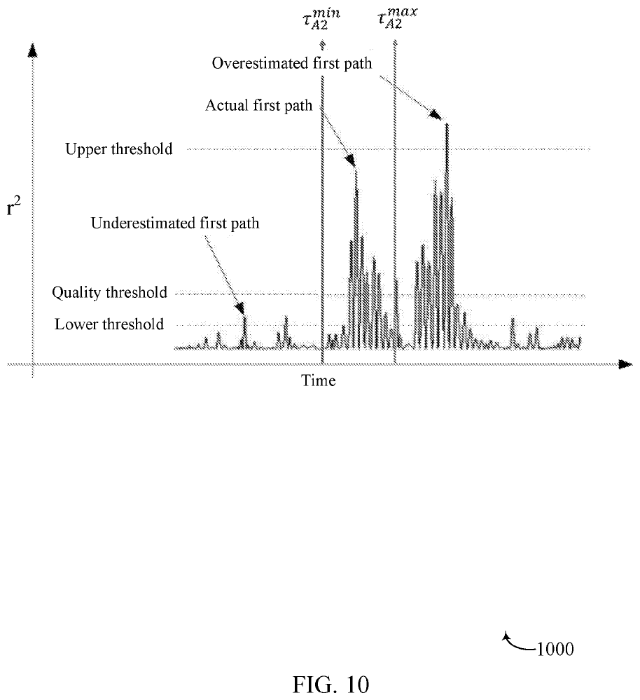

FIG. 10 illustrates at 1000 an example that supports multiple nodes for UE positioning in accordance with aspects of the present disclosure. In the example 1000, for instance, a second anchor node can use estimated position-related parameters from a first anchor node to improve its estimation accuracy and reduce complexity, e.g., to determine

$${τ}_{A 2}^{min} and {τ}_{A 2}^{max} .$$

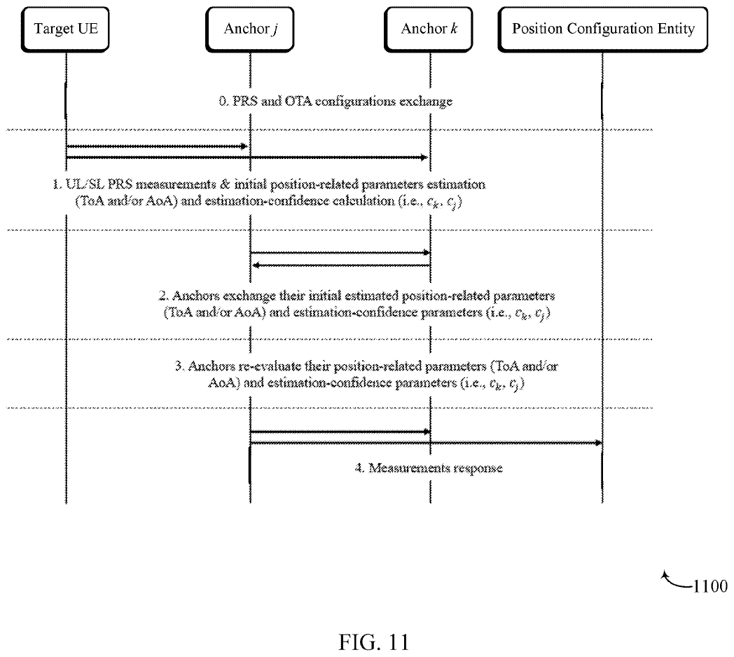

FIG. 11 illustrates a procedure 1100 including a signalling flow that supports multiple nodes for UE positioning in accordance with aspects of the present disclosure. At Step 0, anchor nodes j, k and a Target UE node exchange PRS and OTA configurations with a network positioning configuration entity, e.g., LMF. Further, after receiving the PRS signals from Target UE and estimating position-related parameters and the estimation-confidence parameters, one or more of the anchor nodes j, k at Step 2 transmits its estimated parameters to one or more other of the anchor nodes j, k, such as via a backhaul connection and/or via OTA transmission. At step 3 one or more of the anchor nodes j, k can modify their position-related parameters (e.g., ToA and/or AoA) and estimation-confidence parameters (i.e., cₖ, cⱼ) based on position-related parameters and the estimation-confidence parameters from the other of the one or more other of the anchor nodes j, k, such as to modify their originally calculated position-related parameters. At step 4 one or more of the anchor nodes j, k can transmit a measurements response to the position configuration entity, such as based on modified position-related parameters.

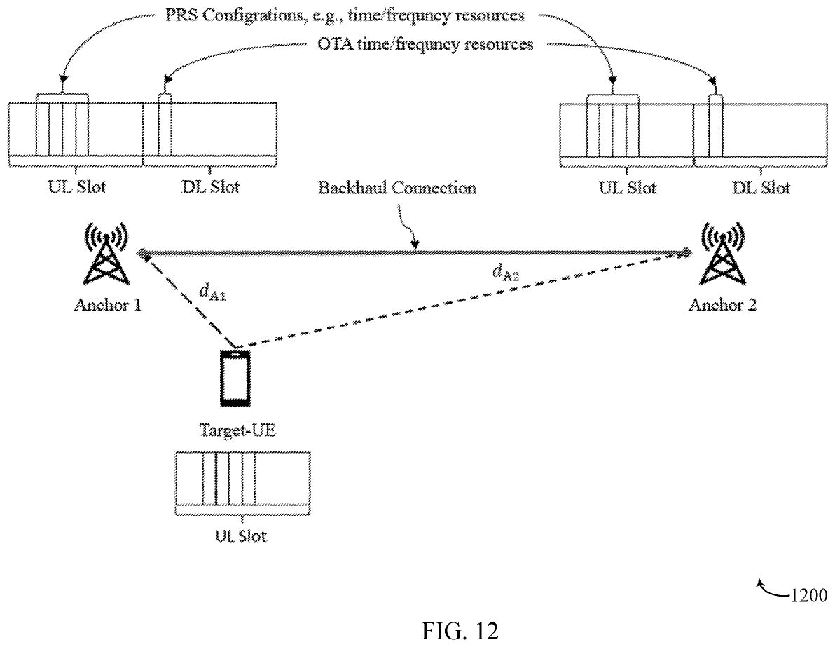

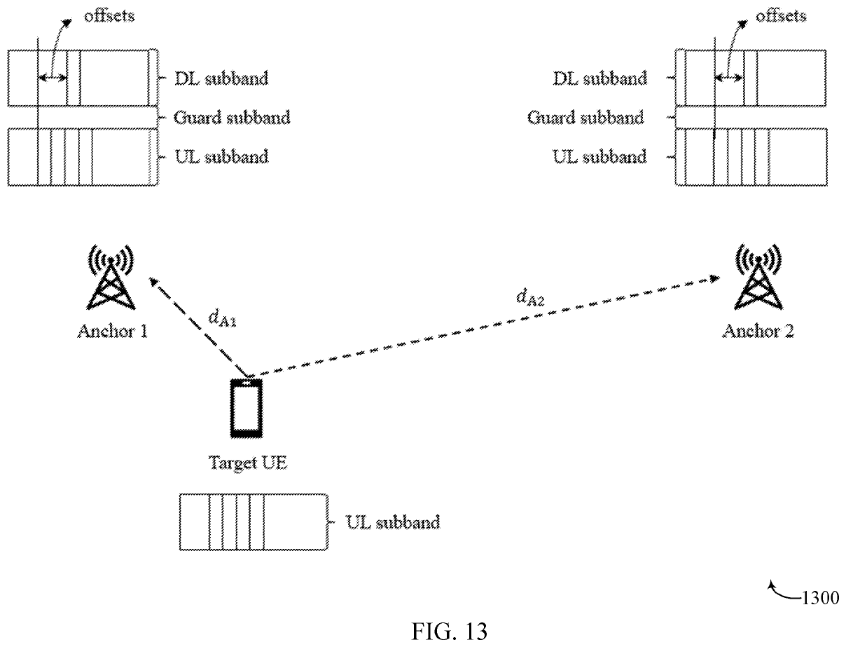

FIG. 12 illustrates at 1200 OTA communication between anchor nodes that supports multiple nodes for UE positioning in accordance with aspects of the present disclosure. For instance, at 1200 the OTA transmission occurs in a DL slot directly after the UL slot. Alternatively, SBFD can be utilized, where the OTA transmission can be configured to occur in a DL subband that is configured to overlap with the UL subband, as such as illustrated at 1300 in FIG. 13. In implementations, depending on the scenario, the time domain resources of the OTA resources can be configured by the network configuration entity with a certain offset, e.g., with respect to the first UL symbol of the PRS time configuration. According to the present disclosure, an offset configuration can consider the processing capability and/or delay of an anchor node as well as the priority of the positioning application. For example, a short time offset can be configured for a timely critical positioning application, and vice-versa.

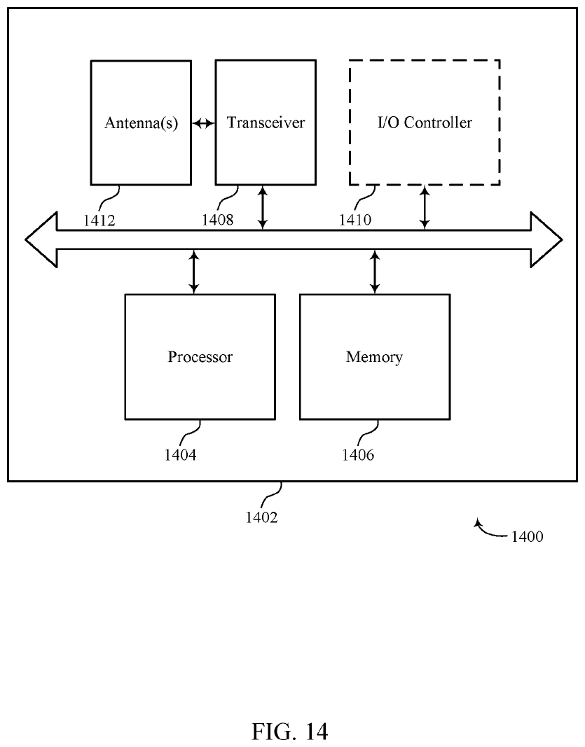

FIG. 14 illustrates an example of a block diagram 1400 of a device 1402 (e.g., an apparatus) that supports multiple nodes for UE positioning in accordance with aspects of the present disclosure. The device 1402 may be an example of a network entity 102 and/or a UE 104 as described herein. The device 1402 may support wireless communication with one or more network entities 102, UEs 104, or any combination thereof. The device 1402 may include components for bi-directional communications including components for transmitting and receiving communications, such as a processor 1404, a memory 1406, a transceiver 1408, and an I/O controller 1410. These components may be in electronic communication or otherwise coupled (e.g., operatively, communicatively, functionally, electronically, electrically) via one or more interfaces (e.g., buses).

The processor 1404, the memory 1406, the transceiver 1408, or various combinations thereof or various components thereof may be examples of means for performing various aspects of the present disclosure as described herein. For example, the processor 1404, the memory 1406, the transceiver 1408, or various combinations or components thereof may support a method for performing one or more of the operations described herein.

In some implementations, the processor 1404, the memory 1406, the transceiver 1408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1404 and the memory 1406 coupled with the processor 1404 may be configured to perform one or more of the functions described herein (e.g., executing, by the processor 1404, instructions stored in the memory 1406). In the context of UE 104, for example, the transceiver 1408 and the processor coupled 1404 coupled to the transceiver 1408 are configured to cause the UE 104 to perform the various described operations and/or combinations thereof.

For example, the processor 1404 and/or the transceiver 1408 may support wireless communication at the device 1402 in accordance with examples as disclosed herein. For instance, the processor 1404 and/or the transceiver 1408 may be configured as or otherwise support a means to receive, at a first anchor node, reference signals from a target UE; process the reference signals to generate a first estimated position-related parameter between the first anchor node and the target UE, and a first confidence value for the first estimated position-related parameter; and transmit a first notification of the first estimated position-related parameter and the first confidence value to a second anchor node.

Further, in some implementations, the processor is configured to cause the apparatus to: receive one or more reference signal time-frequency configurations; and receive the reference signals from the target UE based at least in part on the one or more reference signal time-frequency configurations; the processor is configured to cause the apparatus to generate the first estimated position-related parameter based at least in part on one or more of an estimated time of arrival of a first path between the first anchor node and the target UE, an estimated azimuth angle of arrivals of the reference signals of the first path, or an estimated zenith angle of arrivals of the reference signals of the first path; the processor is configured to cause the apparatus to: receive, from the second anchor node, a second estimated position-related parameter between the second anchor node and the target UE and a second confidence value for the second estimated position-related parameter; modify, based at least in part on the second estimated position-related parameter and the second confidence value, the first estimated position-related parameter to generate a third estimated position-related parameter between the first anchor node and the target UE; and transmit the third estimated position-related parameter and a third confidence value for the third estimated position-related parameter to a network entity; at least one of the first confidence value, the second confidence value, or the third confidence value is based on at least one of link quality with the target UE or whether a line of sight path is available to the target UE.

Further, in some implementations, the processor is configured to cause the apparatus to: compare the first confidence value to a threshold confidence value; and transmit the first notification to the second anchor node based at least in part on the first confidence value meeting the threshold confidence value; the processor is configured to cause the apparatus to: receive, from the second anchor node, a request for a position-related parameter information for the target UE; and transmit the first notification to the second anchor node based at least in part on the request; the processor is configured to cause the apparatus to select the first confidence value from a predetermined set of different confidence values; the processor is configured to cause the apparatus to select the first estimated position-related parameter from a predetermined set of position-related parameter values that represent different position-related parameter ranges; the processor is configured to cause the apparatus to: determine one or more of an estimated azimuth angle of arrivals or an estimated zenith angle of arrivals of the reference signals over a first path between the first anchor node and the target UE based at least in part on one or more of a set of predetermined azimuth angle of arrivals values or a set of predetermined zenith angle of arrivals values that represent different slices of an angular domain; and transmit the one or more of the estimated azimuth angle of arrivals or the estimated zenith angle of arrivals to the second anchor node in conjunction with the first notification.

Further, in some implementations, the processor is configured to cause the apparatus to transmit one or more of the first estimated position-related parameter, the first confidence value, or the one or more of the estimated azimuth angle of arrivals or the estimated zenith angle of arrivals via a backhaul connection; the processor is configured to cause the apparatus to transmit one or more of the first position-related parameter, the first confidence value, or the one or more of the estimated azimuth angle of arrivals or the estimated zenith angle of arrivals via an over-the-air transmission; the processor is configured to cause the apparatus to receive time and frequency resources for the over-the-air transmission, and the time and frequency resources are configured within a downlink subband that overlaps with an uplink subband used for the reference signals; the processor is configured to cause the apparatus to configure time domain resources for the over-the-air transmission within an offset relative to a first time domain symbol of an uplink configuration used for the reference signals; the first anchor node includes a first UE, the second anchor node includes a second UE, and the target UE includes a UE for which an estimated location is to be determined; the first anchor node includes a first network device, the second anchor node includes a second network device, and the target UE includes a UE for which an estimated location is to be determined; one or more of the first network device or the second network device includes at least one of a base station, a gNB, or a roadside unit.

Further, in some implementations, the processor 1404 and/or the transceiver 1408 may be configured as or otherwise support a means to generate a notification including one or more time-frequency configurations and confidence configuration pertaining to distance determination; transmit the notification to a first anchor node; and receive, from the first anchor node, an estimated position-related parameter between the first anchor node and a target UE, and a first confidence value for the first estimated position-related parameter.

Further, in some implementations, the one or more time-frequency configurations are configured for one or more of positioning reference signals or sounding reference signals; the confidence configuration includes a predetermined set of different confidence values; the notification further includes a predetermined set of position-related parameter values that represent different position-related parameter ranges; the notification includes a predetermined set of angle of arrival values that represent different slices of an angular domain for use in position-related parameter determination; the one or more time-frequency configurations identify time and frequency resources within a downlink subband that overlaps with an uplink subband used for reference signals; the first anchor node includes a first UE and the target UE includes a UE for which an estimated location is to be determined; first anchor node includes a first network device and the target UE includes a UE for which an estimated location is to be determined; the first network device includes at least one of a base station, a gNB, or a roadside unit.

The processor 1404 of the device 1402, such as a UE 104, may support wireless communication in accordance with examples as disclosed herein. The processor 1404 includes at least one controller coupled with at least one memory, and the at least one controller is configured to and/or operable to cause the processor to receive, at a first UE comprising a first anchor node, reference signals from a target UE; process the reference signals to generate a first estimated position-related parameter between the first UE and the target UE, and a first confidence value for the first estimated position-related parameter; and transmit a first notification of the first estimated position-related parameter and the first confidence value to a second UE comprising a second anchor node. Further, the at least one controller may be operable to cause the processor 1404 to perform any of the various operations described herein, such as with reference to the device 1402.

The processor 1404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1404 may be configured to operate a memory array using a memory controller. In some other implementations, a memory controller may be integrated into the processor 1404. The processor 1404 may be configured to execute computer-readable instructions stored in a memory (e.g., the memory 1406) to cause the device 1402 to perform various functions of the present disclosure.

The 1406 may include random access memory (RAM) and read-only memory (ROM). The 1406 may store computer-readable, computer-executable code including instructions that, when executed by the processor 1404 cause the device 1402 to perform various functions described herein. The code may be stored in a non-transitory computer-readable medium such as system memory or another type of memory. In some implementations, the code may not be directly executable by the processor 1404 but may cause a computer (e.g., when compiled and executed) to perform functions described herein. In some implementations, the memory 1406 may include, among other things, a basic I/O system (BIOS) which may control basic hardware or software operation such as the interaction with peripheral components or devices.

The I/O controller 1410 may manage input and output signals for the device 1402. The I/O controller 1410 may also manage peripherals not integrated into the device M02. In some implementations, the I/O controller 1410 may represent a physical connection or port to an external peripheral. In some implementations, the I/O controller 1410 may utilize an operating system such as iOS®, ANDROID®, MS-DOS®, MS-WINDOWS®, OS/2®, UNIX®, LINUX®, or another known operating system. In some implementations, the I/O controller 1410 may be implemented as part of a processor, such as the processor M08. In some implementations, a user may interact with the device 1402 via the I/O controller 1410 or via hardware components controlled by the I/O controller 1410.

In some implementations, the device 1402 may include a single antenna 1412. However, in some other implementations, the device 1402 may have more than one antenna 1412 (i.e., multiple antennas), including multiple antenna panels or antenna arrays, which may be capable of concurrently transmitting or receiving multiple wireless transmissions. The transceiver 1408 may communicate bi-directionally, via the one or more antennas 1412, wired, or wireless links as described herein. For example, the transceiver 1408 may represent a wireless transceiver and may communicate bi-directionally with another wireless transceiver. The transceiver 1408 may also include a modem to modulate the packets, to provide the modulated packets to one or more antennas 1412 for transmission, and to demodulate packets received from the one or more antennas 1412.

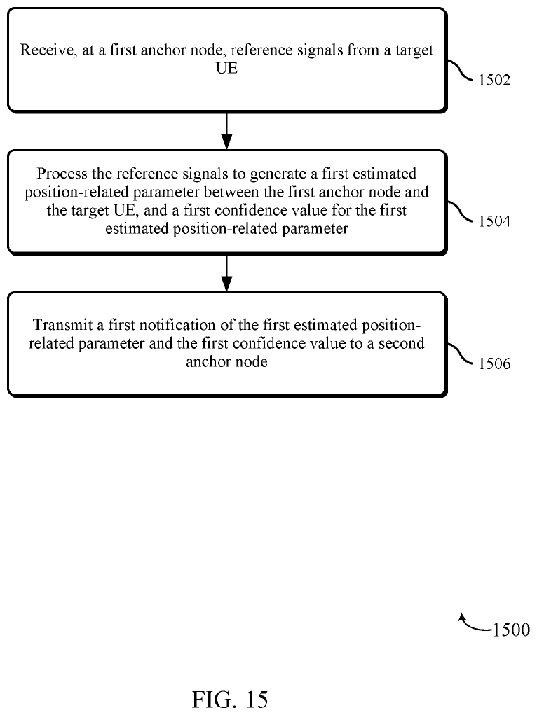

FIG. 15 illustrates a flowchart of a method 1500 that supports multiple nodes for UE positioning in accordance with aspects of the present disclosure. The operations of the method 1500 may be implemented by a device or its components as described herein. For example, the operations of the method 1500 may be performed by a network entity 102 and/or a UE 104 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1502, the method may include receiving, at a first anchor node, reference signals from a target UE. The operations of 1502 may be performed in accordance with examples as described herein. In some implementations, aspects of the operations of 1502 may be performed by a device as described with reference to FIG. 1.

At 1504, the method may include processing the reference signals to generate a first estimated position-related parameter between the first anchor node and the target UE, and a first confidence value for the first estimated position-related parameter. The operations of 1504 may be performed in accordance with examples as described herein. In some implementations, aspects of the operations of 1504 may be performed by a device as described with reference to FIG. 1.

At 1506, the method may include transmitting a first notification of the first estimated position-related parameter and the first confidence value to a second anchor node. The operations of 1506 may be performed in accordance with examples as described herein. In some implementations, aspects of the operations of 1506 may be performed by a device as described with reference to FIG. 1.

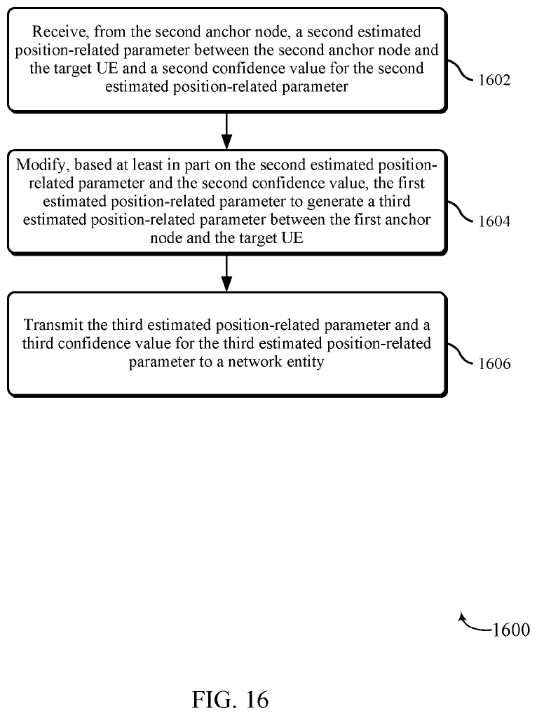

FIG. 16 illustrates a flowchart of a method 1600 that supports multiple nodes for UE positioning in accordance with aspects of the present disclosure. The operations of the method 1600 may be implemented by a device or its components as described herein. For example, the operations of the method 1600 may be performed by a network entity 102 and/or a UE 104 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1602, the method may include receiving, from the second anchor node, a second estimated position-related parameter between the second anchor node and the target UE and a second confidence value for the second estimated position-related parameter. The operations of 1602 may be performed in accordance with examples as described herein. In some implementations, aspects of the operations of 1602 may be performed by a device as described with reference to FIG. 1.

At 1604, the method may include modifying, based at least in part on the second estimated position-related parameter and the second confidence value, the first estimated position-related parameter to generate a third estimated position-related parameter between the first anchor node and the target UE. The operations of 1604 may be performed in accordance with examples as described herein. In some implementations, aspects of the operations of 1604 may be performed by a device as described with reference to FIG. 1.

At 1606, the method may include transmitting the third estimated position-related parameter and a third confidence value for the third estimated position-related parameter to a network entity. The operations of 1606 may be performed in accordance with examples as described herein. In some implementations, aspects of the operations of 1606 may be performed by a device as described with reference to FIG. 1.

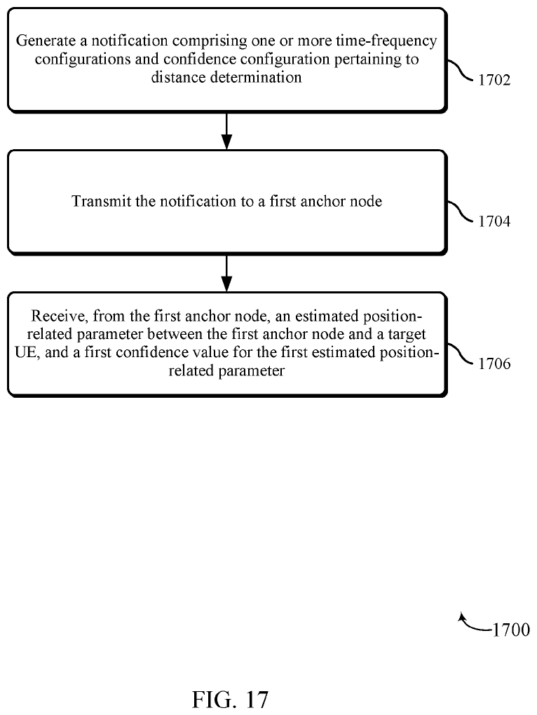

FIG. 17 illustrates a flowchart of a method 1700 that supports multiple nodes for UE positioning in accordance with aspects of the present disclosure. The operations of the method 1700 may be implemented by a device or its components as described herein. For example, the operations of the method 1700 may be performed by a network entity 102 and/or a UE 104 as described with reference to FIGS. 1 through 14. In some implementations, the device may execute a set of instructions to control the function elements of the device to perform the described functions. Additionally, or alternatively, the device may perform aspects of the described functions using special-purpose hardware.

At 1702, the method may include generating a notification comprising one or more time-frequency configurations and confidence configuration pertaining to distance determination. The operations of 1702 may be performed in accordance with examples as described herein. In some implementations, aspects of the operations of 1702 may be performed by a device as described with reference to FIG. 1.

At 1704, the method may include transmitting the notification to a first anchor node. The operations of 1704 may be performed in accordance with examples as described herein. In some implementations, aspects of the operations of 1704 may be performed by a device as described with reference to FIG. 1.

At 1706, the method may include receiving, from the first anchor node, an estimated position-related parameter between the first anchor node and a target UE, and a first confidence value for the first estimated position-related parameter. The operations of M1x06 may be performed in accordance with examples as described herein. In some implementations, aspects of the operations of M1x06 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE) for wireless communication, comprising:
at least one memory; and
at least one processor coupled with the at least one memory and operable to cause the first UE to:
receive reference signals from a target UE;
process the reference signals to generate a first estimated position-related parameter between the first UE and the target UE, and a first confidence value for the first estimated position-related parameter; and
transmit a first notification of the first estimated position-related parameter and the first confidence value to a second UE.

2. The first UE of claim 1, wherein the at least one processor is operable to cause the first UE to:
receive one or more reference signal time-frequency configurations; and
receive the reference signals from the target UE based at least in part on the one or more reference signal time-frequency configurations.

3. The first UE of claim 1, wherein the at least one processor is operable to cause the first UE to generate the first estimated position-related parameter based at least in part on one or more of an estimated time of arrival of a first path between the first UE and the target UE, an estimated azimuth angle of arrivals of the reference signals of the first path, or an estimated zenith angle of arrivals of the reference signals of the first path.

4. The first UE of claim 1, wherein the at least one processor is operable to cause the first UE to:
receive a second estimated position-related parameter between the second UE and the target UE and a second confidence value for the second estimated position-related parameter;
modify, based at least in part on the second estimated position-related parameter and the second confidence value, the first estimated position-related parameter to generate a third estimated position-related parameter between the first UE and the target UE; and
transmit the third estimated position-related parameter and a third confidence value for the third estimated position-related parameter to a network entity.

5. The first UE of claim 4, wherein at least one of the first confidence value, the second confidence value, or the third confidence value is based on at least one of link quality with the target UE or whether a line of sight path is available to the target UE.

6. The first UE of claim 1, wherein the at least one processor is operable to cause the first UE to:
compare the first confidence value to a threshold confidence value; and
transmit the first notification to the second UE based at least in part on the first confidence value meeting the threshold confidence value.

7. The first UE of claim 1, wherein the at least one processor is operable to cause the first UE to:
receive, from the second UE, a request for a position-related parameter information for the target UE; and
transmit the first notification to the second UE based at least in part on the request.

8. The first UE of claim 1, wherein the at least one processor is operable to cause the first UE to select the first confidence value from a predetermined set of different confidence values.

9. The first UE of claim 1, wherein the at least one processor is operable to cause the first UE to select the first estimated position-related parameter from a predetermined set of position-related parameter values that represent different position-related parameter ranges.

10. The first UE of claim 1, wherein the at least one processor is operable to cause the first UE to:
determine one or more of an estimated azimuth angle of arrivals or an estimated zenith angle of arrivals of the reference signals over a first path between the first UE and the target UE based at least in part on one or more of a set of predetermined azimuth angle of arrivals values or a set of predetermined zenith angle of arrivals values that represent different slices of an angular domain; and
transmit the one or more of the estimated azimuth angle of arrivals or the estimated zenith angle of arrivals to the second UE in conjunction with the first notification.

11. The first UE of claim 10, the at least one processor is operable to cause the first UE to transmit one or more of the first estimated position-related parameter, the first confidence value, or the one or more of the estimated azimuth angle of arrivals or the estimated zenith angle of arrivals via a backhaul connection.

12. The first UE of claim 10, wherein the at least one processor is operable to cause the first UE to transmit one or more of the first estimated position-related parameter, the first confidence value, or the one or more of the estimated azimuth angle of arrivals or the estimated zenith angle of arrivals via an over-the-air transmission.

13. The first UE of claim 12, wherein the at least one processor is operable to cause the first UE to receive time and frequency resources for the over-the-air transmission, and wherein the time and frequency resources are configured within a downlink subband that overlaps with an uplink subband used for the reference signals.

14. The first UE of claim 12, wherein the at least one processor is operable to cause the first UE to configure time domain resources for the over-the-air transmission within an offset relative to a first time domain symbol of an uplink configuration used for the reference signals.

15. (canceled)

16. (canceled)

17. (canceled)

18. (canceled)

19. A method performed by a first user equipment (UE), the method comprising:
receiving, reference signals from a target UE;
processing the reference signals to generate a first estimated position-related parameter between the first UE and the target UE, and a first confidence value for the first estimated position-related parameter; and
transmitting a first notification of the first estimated position-related parameter and the first confidence value to a second UE.

20. A network entity for wireless communication, comprising:
at least one memory; and
at least one processor coupled with the at least one memory and operable to cause the network entity to:
generate a notification comprising one or more time-frequency configurations and confidence configuration pertaining to distance determination;
transmit the notification to a first user equipment (UE); and
receive, from the first UE, an estimated position-related parameter between the first UE and a target UE, and a first confidence value for the estimated position-related parameter.

21. A method performed by a network entity, the method comprising:
generating a notification comprising one or more time-frequency configurations and confidence configuration pertaining to distance determination;
transmitting the notification to a first user equipment (UE); and
receiving, from the first UE, an estimated position-related parameter between the first UE and a target UE, and a first confidence value for the estimated position-related parameter.

22. The method of claim 19, further comprising generating the first estimated position-related parameter based at least in part on one or more of an estimated time of arrival of a first path between the first UE and the target UE, an estimated azimuth angle of arrivals of the reference signals of the first path, or an estimated zenith angle of arrivals of the reference signals of the first path.

23. The method of claim 19, further comprising:
receiving a second estimated position-related parameter between the second UE and the target UE and a second confidence value for the second estimated position-related parameter;
modifying, based at least in part on the second estimated position-related parameter and the second confidence value, the first estimated position-related parameter to generate a third estimated position-related parameter between the first UE and the target UE; and
transmitting the third estimated position-related parameter and a third confidence value for the third estimated position-related parameter to a network entity.

24. The method of claim 19, further comprising:
receiving, from the second UE, a request for a position-related parameter information for the target UE; and
transmitting the first notification to the second UE based at least in part on the request.
